(19) United States
(12) Patent Application Publication
(10) Pub. No.: US 2007/0000481 A1
(43) Pub. Date: Jan. 4, 2007

(54) Device for compressing combustion air

(75) Inventors: Michael Baeurle, Ditzingen-Heimerdingen (DE); Carsten Reisinger, Seidenhot (DE)

Correspondence Address: MICHAEL BEST & FRIEDRICH, LLP, 100 E WISCONSIN AVENUE, MILWAUKEE, WI, 53202, US

(73) Assignee: ROBERT BOSCH GMBH, Stuttgart (DE)

(21) Appl. No.: 10/568,857

(22) PCT Filed: Jun. 30, 2004
(86) PCT No.: PCT/DE04/01370

§ 371 Date: Feb. 20, 2006

(30) Foreign Application Priority Data
Sep. 1, 2003 (DE) 103 40 142.3

(51) Int. Cl. F02B 33/00

(52) U.S. Cl. 123/562; 123/559.2

(57) ABSTRACT

The invention relates to a device for compressing combustion air, in particular a device for compressing charge air for an automotive combustion engine, with at least one electrically operated charge-air compressor (12, 14), which features at least one compressor impeller (24) that is arranged in a compressor space (22) and driven by an electric motor (18), as well as with a second, additional charge-air compressor (32, 34), in particular an exhaust-gas turbocharger (34), that is connected serially to the electric charge-air compressor (14), which are connected to one another in terms of flow via connecting means (30). It is proposed in accordance with the invention that connecting means (52) are present, which make it possible to guide already compressed charge air into the compressor space (22) of the electric charge-air compressor (14).

### PRIOR ART

The invention relates to a device for compressing combustion air, in particular a device for compressing charge air for an automotive combustion engine in accordance with the species of Claim 1.

Increasing the power densities of an automotive combustion engine by compressing the charge air required for combusting the fuel is known. As a rule, an exhaust-gas turbocharger is used to do this. In this case, the exhaust-gas turbocharger has a turbine, which is arranged in the exhaust-gas flow of the combustion engine, and a compressor arranged in the charge-air feed of the internal combustion engine.

Particularly in the case of motor vehicle transmissions, exhaust-gas turbochargers have the disadvantage of a delayed and inadequate response characteristic at low rpms of the internal combustion engine (“turbocharger gap”).

In order to improve the charge-air feed, especially in the range of lower rpms of the internal combustion engine, supporting the exhaust-gas turbocharger by means of an electric auxiliary drive is known. This can be achieved, for example, via an electric motor integrated into the exhaust-gas turbocharger. With low rpms of the internal combustion engine, the electric motor drives the shaft of the exhaust-gas turbocharger in a supporting manner. However, this requires both a high rpm load-carrying capacity of the electric motor as well as the possibility of generating a high electrical power demand, which is required due to the high mass moment of inertia of the turbine of an exhaust-gas turbocharger.

In order to avoid these disadvantages, integrating a separate, purely electrically operated auxiliary charger (electric auxiliary compressor) into the charge-air feed of an internal combustion engine is known from U.S. Pat. No. 6,029,452. In this case, the electric auxiliary compressor is operated in series with a conventional exhaust-gas turbocharger and serves for the most part for the pre-compression of the charge air that is fed to the exhaust-gas turbocharger. The advantage of this is that the electric auxiliary compressor that is used separately in the charge-air feed can be optimized for use in the lowest rpm range of the internal combustion engine. In a high rpm range of the internal combustion engine, which for its part leads to a high rpm of the exhaust-gas turbocharger, a bypass solution for example is used to supply the charge air directly to the exhaust-gas turbocharger while bypassing the electric auxiliary compressor that is now not required.

One of the main differences between an electric auxiliary compressor and a classic exhaust-gas turbocharger is the very different propulsive power that is available for these systems. This can be several 10 kW in the case of an exhaust-gas turbocharger, however, in the case of an electric auxiliary compressor, the propulsive power is limited to a maximum of a few kW because of the additional stress on the vehicle's electrical system. This is important particularly when running up the compressor impeller of an electric auxiliary compressor since the starting time is determined mainly by the available propulsive power and the mass moment of inertia of the to-be-accelerated rotor of the auxiliary compressor.

If one observes the turn-on behavior of an electric auxiliary compressor, then one recognizes that precisely in city traffic a clear number of on-states of the compressor is required. With each full-load acceleration, the electric auxiliary compressor must be accelerated in the process to revolutions of approx. 60,000 per minute. In this connection, a mechanical rotational energy of typically 450 wattseconds is absorbed which must be made available by the vehicle's electrical system.

### ADVANTAGES OF THE INVENTION

The device in accordance with the invention for compressing combustion air, in particular for compressing charge air for an automotive combustion engine, with the features of Claim 1 makes reduced electrical energy consumption possible when accelerating the electric auxiliary compressor.

Through the embodiment of the device in accordance with the invention, particularly through the connecting means in accordance with the invention, which make it possible to guide compressed charge air into the compressor space of the electric charge-air compressor, it is possible to facilitate the run-up of the electric auxiliary compressor via a pre-acceleration based on the introduced, compressed air. As a result, both the required acceleration energy of the electric auxiliary compressor as well as its response time until achieving its maximum rpm is reduced.

As a rule, a reduction in charge-air pressure directly precedes the up-shift process during an acceleration phase of the vehicle. Until now, a so-called dump valve was opened to avoid so-called “compressor pumping” in the case of gas removal from the charge-air pressure range. By opening this dump valve, the volume guiding the charge-air pressure is evacuated to approximately the ambient pressure. The pneumatic energy that is freed up by this measure was not used in the process.

With the device in accordance with the invention it is possible to use the pneumatic energy of the charge-air system to support acceleration of the electric auxiliary compressor. Since the up-shift process during an acceleration phase of the vehicle is normally preceded by a reduction in the charge-air pressure via the circulating air valve, the air to be carried off can be used to already accelerate the electric auxiliary compressor for the pending acceleration process of the motor vehicle. Therefore, it is possible to re-establish in a markedly quicker manner the charge-air pressure, which is important for the acceleration phase of the motor vehicle, with the support of the electric auxiliary compressor.

Advantageous further developments and exemplary embodiments of the invention are rendered possible through the features contained in the subordinate claims.

The connecting means, which makes it possible to guide compressed charge air into the compressor space of the electric auxiliary compressor, are arranged on the downstream side of the second charge-air compressor, branch off from there and discharge directly into the compressor space of the electric charge-air compressor. As a result, the pneumatic energy contained in the compressed charge air can be used in an effective manner for the pre-compression of the electric auxiliary compressor.

In this connection, the connecting means discharge directly into a ring channel of the housing of the electric charge-air compressor. The connecting means discharge in an advantageous manner on the low-pressure side of the compression space of the electric charge-air compressor. Through corresponding openings in the wall of the compressor space, a targeted airflow can be achieved for example on the compressor blades of the compressor impeller of the electrical charge-air compressor, thereby supporting the run-up of the compressor impeller.

The ring channel of the compressor advantageously features a plurality of inlet locations for the compressed charge air distributed over its circumference into which the connecting means discharge. In this connection, the inlet locations shall be embodied in such a way that an airflow that is as jet-like as possible is formed for the acceleration of the compressor impeller.

In an advantageous embodiment of the device in accordance with the invention for compressing combustion air, the connecting means, which make it possible to guide compressed charge air into the compressor space of the electric charge-air compressor, feature a valve that prevents the air from the electric charge-air compressor from flowing back via these connecting means in the direction of the second charge-air compressor. This valve or these valves can be embodied advantageously as a membrane valve(s) that can be triggered electronically.

The valve or valves for preventing backflow can be integrated advantageously directly into the housing of the electric charge-air compressor.

Therefore, with the device in accordance with the invention for compressing combustion air, it is advantageously possible to clearly reduce the required acceleration energy of the electric auxiliary compressor as well as its response time. This leads in turn to alleviating the load on the electrical system of the motor vehicle.

Additional advantages of the device in accordance with the invention can be found in the following drawing as well as in the associated description of an exemplary embodiment of the device in accordance with the invention.

### DRAWING

An exemplary embodiment of the device in accordance with the invention for compressing combustion air is depicted in the drawing, which is explained in more detail in the following description. The FIGURE of the drawing, its description and the claims contain numerous features in combination. A person skilled in the art will also observe these individual features expediently and combine them into additional, meaningful combinations, which should therefore also be viewed as disclosed in the description.

The drawing shows:

FIGURE 1 A schematic depiction of an exemplary embodiment of the device in accordance with the invention in a detailed depiction

### DESCRIPTION OF THE EXEMPLARY EMBODIMENT

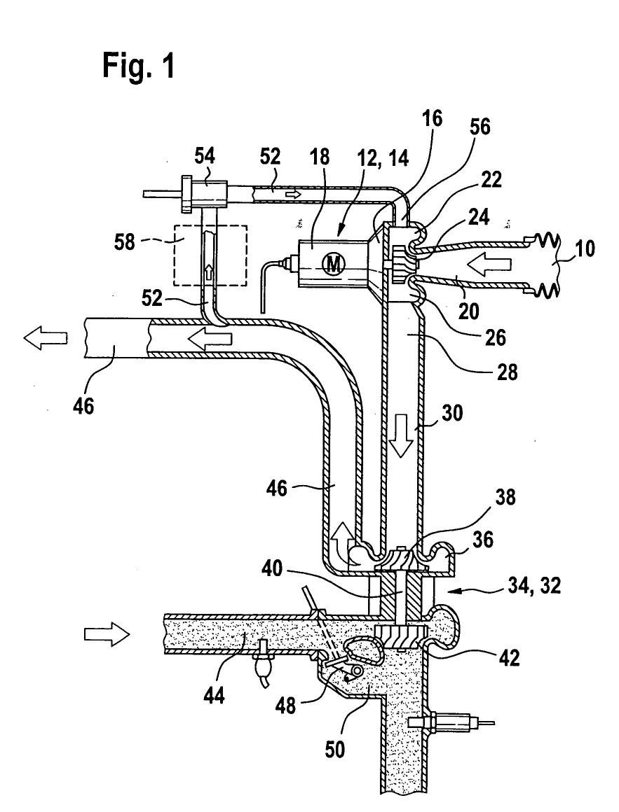

FIGURE 1 shows an exemplary embodiment of a device in accordance with the invention for compressing combustion air, in particular for compressing charge air for an automotive combustion engine in a simplified, schematic detailed depiction.

The to-be-compressed charge air is supplied to a first compressor 12 via an induction opening 10. This first compressor 12 is an electrically operated, so-called auxiliary compressor 14. The electric auxiliary compressor 14 is comprised essentially of a compressor unit 16 and an electrical drive unit 18.

The to-be-compressed charge air is supplied to the compressor space 22 of the electric auxiliary compressor 14 via an inlet opening 20. A compressor impeller 24 driven by a shaft from the electrical drive unit 18 is arranged in the compressor space 22. The to-be-compressed charge air is accelerated in the compressor space and is typically guided out of the electric auxiliary compressor 14 via a ring channel 26 and an outlet opening 28.

The electric auxiliary compressor 14 of the device in accordance with the invention is connected via connecting means 30 with a second charge-air compressor 32, which is embodied as an exhaust-gas turbocharger 34 in the exemplary embodiment in FIGURE 1.

The exhaust-gas turbocharger 34 has a compressor impeller 38 arranged in a compressor space 36, which is driven by a turbine 42 via a shaft 40, which turbine is arranged in the exhaust-gas flow of a combustion engine (not shown) of a motor vehicle. The kinetic energy of the hot exhaust-gas flow 44 is used in a known manner to drive the turbine 42, which therefore in turn can accelerate the compressor impeller 38 of the exhaust-gas turbocharger 34.

The air that is pre-compressed by the electric auxiliary compressor 14 is further compressed in the compressor space 36 of the exhaust-gas turbocharger 34 and supplied via connecting means 46 to the combustion engine (not shown in FIGURE 1). These connecting means 46 can also still feature a charge-air cooler (not shown) or a throttling valve for the charge-air flow. The compressor power of the exhaust-gas turbocharger can be controlled via a valve 48, which regulates the volume flow of the exhaust gas through a bypass channel 50 around the drive turbine of the exhaust-gas turbocharger 34.

In principle, another sequence of compressor stages is also possible.

This two-stage device for compressing charge air makes it possible to largely avoid the so-called turbocharger gap, which occurs at low engine rpms and therefore with a low exhaust-gas flow 44. In the range of low engine rpms, at which, due to its drive turbine 42, the classic exhaust-gas turbocharger 34 cannot generate high rpms and thus the desired high compression ratio, the electric auxiliary compressor 14 is switched on in order to achieve a desired pre-compression of the charge air. Because of this electric auxiliary compressor it is possible to compensate for the disadvantage of a delayed and inadequate response characteristic of an exhaust-gas turbocharger.

As a result, due to its function the electric auxiliary compressor is always only switched on in the short term and requires a response characteristic that is as quick as possible. This process is typical of acceleration situations and occurs in particular with practically all gear changes (up-shifting) of the vehicle. If one observes the turn-on behavior of an electric auxiliary compressor, then one recognizes that precisely in city traffic a clear number of on-states of the compressor is required. With each full-load acceleration, the electric auxiliary compressor must be accelerated to approx. 60,000 revolutions per minute. In this connection, a mechanical rotational energy in the range of 400 to 500 wattseconds is absorbed, which must be made available by the motor vehicle's electrical system. As a rule, a reduction in charge-air pressure via a so-called circulating air valve directly precedes the up-shift process during an acceleration phase. Until now the charge-air pressure in the system was reduced by opening the so-called dump valve in order to avoid, for example, compressor pumping in the case of “gas removal.” As a result, the volume guiding the charge-air pressure is evacuated to approximately the ambient pressure. The pneumatic energy that is freed up by this measure was not used until now.

Connecting means 52 are present in the device in accordance with the invention for compressing charge air, and these connecting means make it possible to guide already compressed charge air directly into the compressor space of the electric charge-air compressor in order to thereby facilitate a quicker run-up of the electric auxiliary compressor via a pre-compression.

In the exemplary embodiment of the device in accordance with the invention shown in FIGURE 1, the connecting means 52 branch off from the connecting means 46, which connect the exhaust-gas turbocharger with the combustion engine. The connecting means 52 lead directly into the compressor space 22 of the electric auxiliary compressor 14 via a valve 54. Openings 56 can be provided for this, for example distributed over the circumference of the ring channel 26 of the electric auxiliary compressor 14, and these openings guide the compressed charge air that is branched-off via the connecting means 52 in a purposeful manner into the ring channel 26 and then to the compressor blades of the compressor impeller 24. As a result of this jet-like introduction of the compressed charge air to the compressor blades of the compressor impeller of the electric auxiliary compressor, pre-compression of the auxiliary compressor is possible, which leads to a quicker run-up, i.e., to a short response characteristic of the auxiliary compressor. In addition, using the pneumatic energy of the charge-air system means that reduced energy absorption from the vehicle's electrical system, is possible when accelerating the electric auxiliary compressor.

The circulating air inlet location is integrated in an advantageous manner directly into the electric auxiliary compressor 14 and can for example also contain one or more valves, which prevent backflow of the to-be-compressed charge air via the connecting means 52. In addition, make sure that the charge air to be accelerated via the electric auxiliary compressor is carried off through the exit opening 28 of the auxiliary compressor and therefore can be supplied to the downstream exhaust-gas turbocharger 34. An outflow of the charge air compressed by the electric auxiliary compressor via the connecting means 52 must be prohibited.

Provisions can be made in other embodiments for the connecting means 52 to include a storage volume 58 into which the compressed charge air can be guided and then stored at high pressure. For example, a valve arrangement can then release the compressed charge air at a desired point in time directly into the compressor space of the electric auxiliary compressor.

A meaningful utilization of the pneumatic charge-air energy with negative change of load of the combustion system is possible with the device in accordance with the invention. As a rule, a reduction in charge-air pressure via a circulating air valve directly precedes the up-shift process during an acceleration phase and then the charge-air pressure is re-established with the support the electric auxiliary compressor. The device in accordance with the invention can use the reduction of the charge-air pressure in an advantageous manner for the pre-compression of the electric auxiliary compressor. As a result, both the required acceleration energy of the electric auxiliary compressor as well as its response time until achieving its maximum rpm is reduced. The pneumatic energy of the charge-air system, even when taking a moderate degree of efficiency into account for transferring its energy to the electric auxiliary compressor, includes a not insignificant proportion of the required rotational energy for an electric auxiliary compressor.

The device in accordance with the invention is not restricted to the exemplary embodiment depicted in FIGURE 1.

In particular, the device in accordance with the invention is not restricted to the use of an electric auxiliary compressor and an exhaust-gas turbocharger.

1. Device for compressing combustion air, in particular a device for compressing charge air for an automotive combustion engine, with at least one electrically operated charge-air compressor (14), which features at least one compressor impeller (24) that is arranged in a compressor space (22) and driven by an electric motor (18), as well as with a second, additional charge-air compressor (32), in particular an exhaust-gas turbocharger (34), that is connected serially to the electric charge-air compressor (14), which are connected to one another in terms of flow via connecting means (30), characterized in that connecting means (52) are present, which make it possible to introduce compressed charge air into the compressor space (22) of the electric charge-air compressor (14).

2. Device for compressing combustion air according to claim 1, characterized in that the connecting means (52) branch off on the downstream side of the second charge-air compressor (32, 34) and discharge into the compressor space (22) of the electric charge-air compressor (14).

3. Device for compressing combustion air according to claim 2, characterized in that the connecting means (52) discharge directly into a ring channel (26) of the housing of the electric charge-air compressor (14).

4. Device for compressing combustion air according to claim 3, characterized in that the ring channel (26) is embodied on the low-pressure side of the electric charge-air compressor (14).

5. Device for compressing combustion air according to claim 1, characterized in that the connecting means (52) have a valve (54), in particular a membrane valve that can be triggered electronically.

6. Device for compressing combustion air according to claim 5, characterized in that the valve is integrated into a housing of the electric charge-air compressor (14).

7. Device for compressing combustion air according to claim 1, characterized in that the connecting means (52) have a storage volume (58).

8. Device for compressing combustion air according to claim 2, characterized in that the connecting means (52) have a valve (54), in particular a membrane valve that can be triggered electronically.

9. Device for compressing combustion air according to claim 3, characterized in that the connecting means (52) have a valve (54), in particular a membrane valve that can be triggered electronically.

10. Device for compressing combustion air according to claim 4, characterized in that the connecting means (52) have a valve (54), in particular a membrane valve that can be triggered electronically.

11. Device for compressing combustion air according to claim 2, characterized in that the connecting means (52) have a storage volume (58).

12. Device for compressing combustion air according to claim 3, characterized in that the connecting means (52) have a storage volume (58).

13. Device for compressing combustion air according to claim 4, characterized in that the connecting means (52) have a storage volume (58).

14. Device for compressing combustion air according to claim 5, characterized in that the connecting means (52) have a storage volume (58).

15. Device for compressing combustion air according to claim 6, characterized in that the connecting means (52) have a storage volume (58).

16. Device for compressing combustion air according to claim 8, characterized in that the valve is integrated into a housing of the electric charge-air compressor (14).

17. Device for compressing combustion air according to claim 9, characterized in that the valve is integrated into a housing of the electric charge-air compressor (14).

18. Device for compressing combustion air according to claim 10, characterized in that the valve is integrated into a housing of the electric charge-air compressor (14).

19. Device for compressing combustion air according to claim 18, characterized in that the connecting means (52) have a storage volume (58).
